(19) United States
(12) Patent Application Publication
(10) Pub. No.: US 2008/0190055 A1
(43) Pub. Date: Aug. 14, 2008

(54) Sealing Device Between Two Structural Bodies

(75) Inventor: Rene P. Schmid, Oberweningen (CH)

Correspondence Address: LACKENBACH SIEGEL, LLP, LACKENBACH SIEGEL BUILDING, 1 CHASE ROAD, SCARSDALE, NY, 10583, US

(73) Assignee: Rena P. Schmid

(21) Appl. No.: 11/659,527

(22) PCT Filed: Aug. 3, 2005
(86) PCT No.: PCT/EP2005/008426

§ 371 Date: Nov. 12, 2007

(30) Foreign Application Priority Data
Aug. 3, 2004 (DE) 102004037604.2

(51) Int. Cl. E04B 1/68; F16J 15/02; E04B 1/684; E04G 21/14

(52) U.S. Cl. 52/259; 277/645; 52/745.21; 52/741.41

(57) ABSTRACT

The invention relates to a sealing device (1) for sealing off a joint (4) between a first and a second structural body (5, 6), in particular between concrete bodies, in the region of the joint (4) an injection duct (3) being provided, which is filled or can be filled with a sealing medium in order to seal off the joint (4) and/or voids (4a, 4b) present in the region of the joint (4), the injection duct (3) having arranged in it an extruded spacer body filling the injection duct (3), and the injection duct (3) being formed solely by walls of the structural bodies (5, 6), the extruded spacer body being a hollow profile extrusion (2) which has inside it at least one hollow profile duct preferably continuous in the longitudinal direction and a three-dimensional shape which withstands the hydrostatic pressure of the wet concrete during the pouring of the second structural body and can be pressed in when sealing medium is pressed into the injection duct (3) and which narrows the cross section and is set back from the walls of the injection duct (3), preferably as far as the joint region. The region relates, furthermore, to a hollow profile extrusion for a sealing device and also to the sealing-off method.

The invention relates to a sealing device arranged in a working joint between two structural bodies and having an injection duct. The invention relates, moreover, to an extruded spacer body for keeping an injection duct free during the concreting of the second structural body.

Sealing devices used at the present time against pressing water in a working joint between two structural bodies, for example between a plate-shaped sole and a concrete wall arranged on it or between two sole plates or in a pipe leadthrough between a pipe and a concrete body or the like surrounding the pipe, have a, for example, tube-like duct body laid on the surface of one structural body and mostly consisting of plastic, which forms a passage duct for leading through a sealing medium and which has outlet orifices through which sealing material travels out of the passage duct into that region of a joint which is to be sealed off.

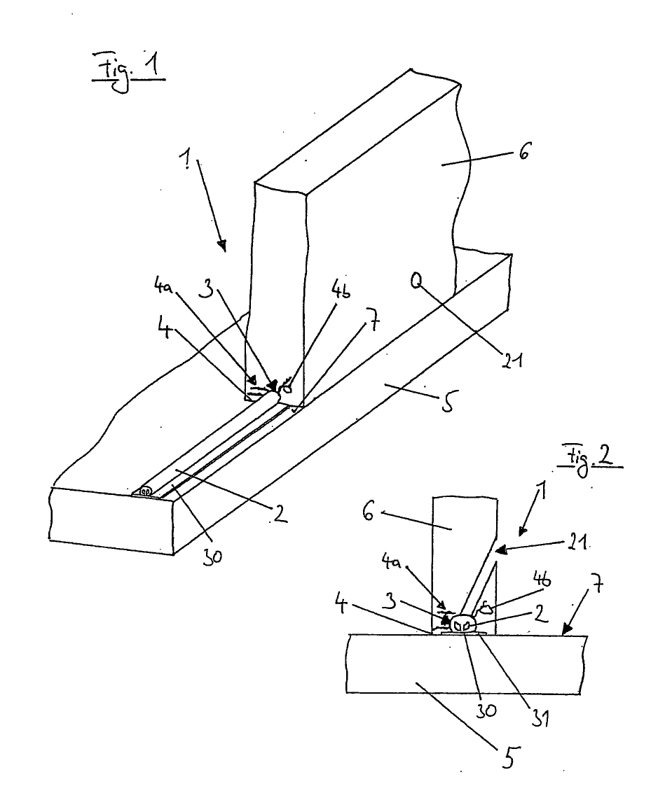

These sealing duct bodies have many different three-dimensional shapes. They are in cross section, for example, round (G 89 15 525) or triangular (DE 197 02 248 A1, FIG. 2) or oval (DE 41 40 616 A1, FIG. 2) or hood-shaped (DE 200 08 203 U1, FIG. 1, EP 0 418 699 A1, G 94 02 078, FIG. 1) or square (G 94 02 078, FIGS. 5 to 10).

In many instances, the outlet orifices are covered by valve bodies which are intended, during the concreting of the second structural body, to prevent concrete material from entering the outlet orifices and blocking the orifices and/or the passage duct (for example, G 94 02 078, G 89 15 525, DE 200 08 203 U1, DE 414 40 616 A1, DE 197 02 248 A1, FIG. 2).

Moreover, some of these sealing devices are equipped on the outside with swelling strips which, upon on the ingress of water, swell and seal off joint regions (for example, DE 197 02 248 A1, FIG. 2, DE 41 40 616 A1).

The duct bodies are designed in terms of material and of three-dimensional shape such that the three-dimensional shape withstands, without deformation, the hydrostatic wet concrete pressure during the concreting of the second structural body, so that the passage duct remains open. Liquid sealing material is pressed into the passage duct from outside, penetrates through outlet orifices of the duct body into free spaces to be sealed of f in the region of the working joints and seals off the working joints.

The known sealing devices have the disadvantage that the walls of the duct bodies cover relatively large fractions of the area of the structural body surfaces and joint regions which surround the duct body and thereby impede the penetration of sealing material into voids of the structural bodies. Moreover, it is not possible with sufficient reliability to ensure that, during the concreting of the second structural body, the outlet orifices of the duct body are at least partly not blocked or that the duct body does not collapse. In addition, in most duct bodies, the flow path for the sealing medium is too long and/or is subject to too much resistance.

A method has also already been described whereby spacer material for keeping an injection duct free during the concreting of the second structural body should be used for a sealing device (DE 34 29 815 C2) . In this case, before the concreting of the next portion, a first liquid plastic should be applied in the form of an extrusion in a groove of the first concreting portion to the free face which closes of a concreted portion and forms a face of the working joint, said liquid plastic expanding after being applied. After the curing of the foam formed by the first liquid plastic, the next portion adjacent to the working joint should be concreted, during which the foam should fill an injection duct and keep the latter free of concrete. In order to press together the injection duct filled with foam, a second liquid plastic should be introduced at such a high pressure that the foam body is compressed by the second liquid plastic, specifically to a volume which is smaller than the volume of the groove, so that the second liquid plastic can travel into the region of the working joint (FIG. 3). This complicated sealing method described is uncontrollable or is impracticable, because the foaming extrusion does not afford any uniform three-dimensional shape, and the foamed extrusion experiences a considerable lift in the wet concrete of a second structural body and may come loose from the surface of the first structural body and float up. Moreover, due to ageing, the foam relatively quickly loses its three-dimensional shape and consequently also its provisional sealing function in the working joint. In addition, during pressing together, the second liquid plastic presses material of the first cured plastic foam into or in front of the voids to be sealed off in the working joint region, and the first plastic blocks the duct-side entrance of the voids, so that the second liquid plastic cannot penetrate into the voids.

This known method has therefore not had any practical application. Instead, the proven principle with the solid duct bodies has been pursued and its functioning optimized, although this results in a complication of the duct bodies and therefore in an appreciable increase in cost of the injection method.

The object of the invention is to provide a sealing device between the working joint of two structural bodies, which can be produced in a simple way by simple means and makes optimal sealing off possible.

This object is achieved by means of the features of claim 1.

Advantageous developments of the invention are characterized in the subclaims.

According to the invention, to keep an injection duct free in a second structural body, an extruded spacer body is used, which consists of a hollow profile extrusion and which is designed with supporting walls for absorbing hydrostatic pressure of the second structural body. The three-dimensional framework structure and the material selection are such that the extruded body is compressed at most insignificantly during concreting, but, on the other hand, can be compressed mainly by sealing medium pressed against the extruded body from outside, so that part regions of the injection duct are released for the throughflow of sealing medium. In this case, the three-dimensional shape and the material of the extruded body are selected such that, under one-sided compressive load by the pressure medium, the casing of the extruded body is dented and the adjacent casing regions are thereby drawn off from the inner wall of the injection duct. Thus, throughflow space for the sealing medium is released not only in the longitudinal direction of the injection duct, but also in the transverse direction of the injection duct space, so that the sealing medium can advance laterally into the working joint plane and, furthermore, into voids.

In a particular embodiment of the invention, the cavity or the chambers in the hollow profile extrusion are put, before the concreting of the second structural body, under an internal pressure which counteracts the hydrostatic pressure of the wet concrete. This internal pressure may be generated, for example, by means of compressed air or a liquid and can be cancelled again after the abatement of the hydrostatic pressure. However, the internal pressure may even persist or expediently also be increased after the setting of the concrete, so that the effect, intended by the hollow profile extrusion, of a provisional sealing off of the working joint is further increased. The internal pressure is cancelled only when pressing by sealing medium is to take place.

In a further variant according to the invention, before pressing together, a vacuum is generated in the chambers of the hollow profile extrusion, so that the resistance of the hollow profile extrusion to deformation during pressing together is reduced or the hollow profile extrusion is collapsed and comes loose at least in part regions from the injection duct walls.

To fill the chambers with a fluid and/or to evacuate the chambers, corresponding valve devices known per se are arranged on the hollow profile extrusions and/or the hollow profile extrusion is designed to be closed at least at one end.

In this embodiment of the invention, a more flexible material which can be dented by means of a lower sealing medium pressure may be selected for the hollow profile extrusion. Moreover, in this method according to the invention, the internal pressure can be varied and adapted to the hydrostatic pressure to be expected, so that the material selection and/or the three-dimensional structure for the hollow profile extrusion do not have to depend on the hydrostatic pressure to be expected.

In a further particular embodiment of the invention, ribs running longitudinally are integrally formed particularly on the side walls of the hollow profile extrusion and in the manner of a labyrinth seal can impede a flow around the hollow profile extrusion of pressing water penetrating via the working joint.

Preferably in combination with the ribs, there is also provision, according to the invention, particularly in the working joint region, for arranging on the hollow profile extrusion a swelling strip consisting of material which swells upon the ingress of water. Expediently, the swelling strip is integrally formed in one piece and constitutes the bearing wall on the working joint face of the first structural body, the swelling strip preferably projecting with edge webs on both sides of the hollow profile body extrusion.

The pressing together of the sealing device according to the invention by means of a sealing medium may take place in the usual way from one end of the hollow profile extrusion. The sealing medium travels in the direction of the other end, at the same time denting the hollow profile body extrusion and forming a corresponding free space in the injection duct. Sealing medium then penetrates from the free space into voids of the working joint region and seals off these voids.

The invention, however, also affords two simple possibilities for pressing together with sealing medium only where actually leaky places occur in the working joint region, in that the injection duct is made accessible from the outside of the second concrete body.

According to one possibility, pressing tubes or removable cylindrical bars, for example of plastic, which keep a feed hole free for sealing material, are laid at predetermined intervals during the mounting of the hollow profile body extrusion, so as to lead outward from the injection duct through the second structural body. For mounting the hollow profile body extrusion on the surface of the first concrete body, in particular, the conventional laying means are used, which do not cause leaks in the hollow chambers of the hollow profile body extrusion in such a way that wet concrete material of the second structural body, during concreting, and/or sealing material, during pressing together, can penetrate into the hollow chambers.

Sealing material can be pressed in at any time through these orifices to the injection duct at specific locations on the injection duct which are located directly in or in the vicinity of leaky working joint regions.

According to the second possibility, a bore is driven through the second structural body as far as the injection duct in the region of a leaky working joint location and sealing material is pressed in through this bore or through a pipe inserted into the bore.

Sealing material can be saved by virtue of both of these pressing possibilities, because only the leaky places of the working joint need to be pressed together, and the injection duct does not have to be pressed together over its entire length.

According to the invention, the spacer body used is a tubular hollow profile extrusion which has at least one hollow profile duct which is preferably continuous in the longitudinal direction and which is inaccessible to sealing medium from outside and makes it possible that, when liquid curing sealing material is pressed into the injection duct, the pressing-in pressure acts from outside on the hollow profile extrusion and displaces hollow profile extrusion regions into the cavity of the hollow profile duct. Passage space for sealing medium is thereby provided. In this case, the three-dimensional shape of the hollow profile extrusion, in particular the arrangement of the hollow profile duct in the hollow profile extrusion, and the three-dimensional shape of the hollow profile duct are selected such that passage spaces for the sealing medium can be provided outside the hollow profile extrusion and are released laterally as far as the joint region, so that the sealing material can be pressed into the joint region.

According to the invention, the three-dimensional shape and the material selection are selected such that the hollow profile extrusion has a three-dimensional non-deformability which withstands the hydrostatic pressure of the wet concrete mass of the second concrete portion. Such a hollow profile extrusion requires relatively high pressing forces of the sealing medium for a denting or displacement of hollow profile extrusion regions into the cavities of the hollow profile duct or of the hollow profile ducts.

For the application of lower pressing forces, the invention provides for generating in the hollow profile duct a vacuum which generates or assists a predetermined denting before or during injection.

According to one embodiment of the invention, a three-dimensional nondeformability for the hollow profile extrusion is selected which does not readily withstand the wet concrete pressure, and, before the pouring of the wet concrete, an internal pressure in the hollow profile duct is generated which ensures the required three-dimensional nondeformability. After the stiffening and/or setting of the concrete, the internal pressure, which may be generated by means of a gaseous or liquid medium, is broken down, so that the three-dimensional nondeformability of the hollow profile extrusion is reduced and the denting of the hollow profile extrusion can be implemented by means of relatively low pressing forces of the pressed-in sealing medium. In this case, too, of course, to assist denting even further, a vacuum may be applied in the hollow profile duct when sealing material is being pressed in.

According to the invention, in particular, hollow profile extrusions with a plurality of hollow profile ducts arranged laterally next to one another and/or arranged one above the other are used, and, for the directed assistance of the denting of specific regions of the hollow profile extrusion, only the adjacent duct or only the adjacent ducts are subjected to a vacuum, so that passage ducts are predetermined for the sealing medium in a directed manner and the sealing medium is steered in a directed manner in a specific direction to joint regions.

The three-dimensional shape of the hollow profile extrusions used according to the invention is selected such that denting takes place in predetermined regions, so that predetermined throughflow ducts for the sealing medium can be generated. For this purpose, the supporting walls and preferably also the side walls separating the cavities of the hollow profile ducts have predetermined bending regions which extend in the longitudinal direction and which ensure defined material deformation during denting.

An exemplary embodiment of the invention is explained in more detail below with reference to the figures in which:

FIG. 1 shows diagrammatically a perspective and partially cutaway illustration of two structural bodies separated by a working joint, with a sealing device according to the invention.

FIG. 2 shows diagrammatically a cross section through the structural bodies according to FIG. 1.

FIGS. 3-9 show cross sections through hollow profile extrusions according to the invention.

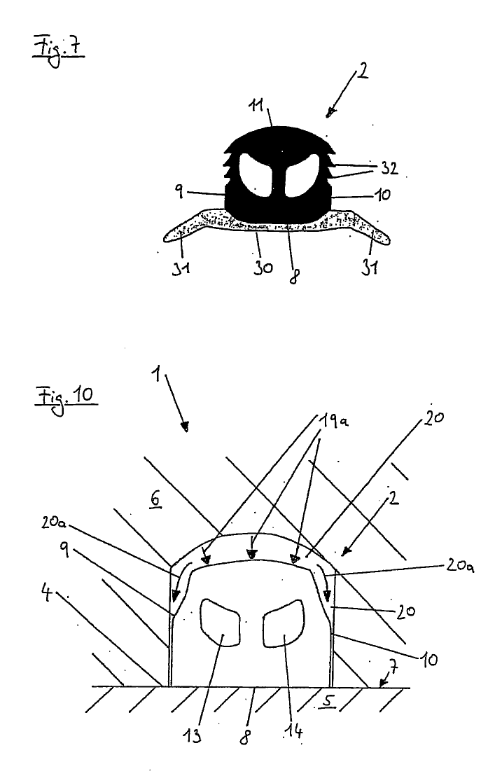

FIG. 10 shows a cross section through a hollow profile extrusion according to the invention, as shown in FIG. 3, in the compressed state.

The sealing device 1 consists essentially of an injection duct 3 in the region of a joint 4 between two structural bodies 5, 6 (FIG. 1, 2) and of an extruded spacer body which is arranged therein and which is designed as a hollow profile extrusion 2. The structural bodies 5, 6 are, for example, two concrete bodies, such as a sole and a wall, or two concrete plates of a sole or two concrete walls or joint regions between a pipe and a concrete body.

The injection duct 3 is produced in that the hollow profile extrusion is arranged, for example laid, on the first concrete body 5 and screwed. The second structural body 6 is subsequently concreted onto the first structural body 5 so as to form the joint 4, the hollow profile extrusion 2, as a spacer body, keeping the injection duct 3 free of concrete material. The fastening of the hollow profile extrusion 2 prevents the latter from floating up or changing its position in the still liquid wet concrete.

The hollow profile extrusions preferably consist of an elastomeric material, for example of rubber, or of polyvinylchloride.

Particularly advantageous three-dimensional shapes for the hollow profile extrusions are illustrated in FIGS. 3 to 9. FIG. 10 illustrates the advantageous variation in three-dimensional shape when sealing material is pressed in.

The hollow profile extrusion according to FIG. 3 has a planar bottom face 8 seated on the planar concrete surface 7 of the concrete body 5, two planar side faces 9, 10 running upward at right angles and a barrel-vaulted top face 11. Inside the hollow profile extrusion 2 are introduced laterally next to one another hollow profile ducts 13, 14 which are separated from one another by a transversely centrally arranged supporting wall 12 oriented vertically or parallel to the side faces 9, 10 and which extend preferably continuously in the longitudinal direction. The cross-sectional shape of the ducts 13, 14 is preferably identical and is expediently arranged symmetrically to the vertical transverse center plane 15 of the hollow profile extrusion 2; moreover, the cross-sectional shape is approximately triangular and produces a planar supporting wall face 16 which merges into a concave duct face 17 in the form of an arc of a cylinder, located on the bottom-face and side-face side and into a convex duct face 18 in the form of an arc of a cylinder located on the top-face side. This configuration of the hollow profile extrusion 2 results in a top wall 19 of horizontally lenticular cross section.

The ducts 13, 14 are, for example, designed to be closed on both sides or open on both sides. They are preferably designed to be open on one side, a valve device for subjecting the ducts 13, 14 to excess pressure and/or a vacuum preferably being provided at the open end. The sealing medium is pressed in preferably at that end of the injection duct 3 at which the closed end of the ducts 13, 14 is present. When sealing medium is being pressed into the injection duct 3, for example from one end face of the hollow profile extrusion 2, between the top face 11 and the wall of the injection duct 3, as indicated by arrows 19a in FIG. 10, the hollow profile extrusion 2 is pressed onto the concrete surface 7 (FIG. 10), the top face 11 being pressed in the direction of the concrete surface 7, so that a passage duct 20, as a part region of the injection duct 3, is obtained above the top face 11. By the hollow profile extrusion 2 being compressed and the side walls 9, 10 being forced into the cavities of the hollow profile ducts 13, 14, the cross-sectional shape of the hollow profile extrusion 2 changes. In this case, the side faces 9, 10 shift back from the wall of the injection duct 3, with the result that the passage duct 20 opens laterally as far as the joint 4. The sealing medium can thus penetrate laterally past the hollow profile extrusion 2 into the joint region, as indicated in FIG. 10 by arrows 20a, and can fill the latter and also voids, such as cracks 4a and cavities or pores 4b, which are illustrated diagrammatically in FIG. 1 and FIG. 2.

In a further preferred embodiment, at least in one of the two structural bodies 5, 6, at least one feed hole 21 is provided (FIGS. 1, 2) which runs, for example, transversely with respect to the injection duct 3, leads from outside to the injection duct 3 and passes through the structural body and through which sealing medium can be injected into the injection duct 3 in a directed manner at a specific or predetermined location in the joint region. By the access hole 21 issuing in the zenith region of the top face 11, as illustrated diagrammatically in FIGS. 1, 2, the hollow profile extrusion 2 is compressed from above in a similar way to that in the event of injection into one end of the injection duct 3 between the top face 11 and the injection duct wall. If the feed hole 21 issues laterally from the zenith region into the injection duct 3, this leads to an asymmetric deformation of the hollow profile extrusion 2 (not illustrated), the hollow profile extrusion 2 being pressed with one of the two side faces 9, 10 against the adjacent wall of the injection duct 3. On the other side face, the passage duct 20 extends as far as the joint region. The access hole 21 is advantageously formed during concreting or, in a preferred variant, is introduced in a directed manner as a bore after the setting of the concrete.

In a variant of the sealing device, a preferably one-piece swelling strip 30 is arranged (FIG. 7) on the bottom face 8 of the hollow profile extrusion 2 and forms a bearing wall on the concrete surface 7 (FIG. 2). The swelling strip 30 is designed as flat strip which preferably has two edge webs 31 which project on both sides of the hollow profile extrusion 2 and which advantageously bend away from the hollow profile extrusion 2 at an obtuse angle. To lay the hollow profile extrusion 2 onto the concrete surface 7, some pressing force must be exerted, so that the swelling strip 30 lies over its area on the concrete surface 7. The swelling strip 30 consists of material swelling upon the ingress of water, such as, for example, swelling rubber or swelling plastic, in particular swellable polyurethane. If in the joint region there are slight leaks which result in a penetration of water into the joint region, the swelling strip 30, simply by swelling, prevents a penetration of water, even without an injection of sealing medium, as described, being necessary.

Preferably, particularly on the side faces 9, 10 of the hollow profile extrusion 2, ribs 32 running in the longitudinal direction are integrally formed (FIG. 7), which in the manner of a labyrinth seal impede a flow around the hollow profile extrusion 2 of pressing water penetrating via the joint 4. Particularly in combination with one another, the swelling strip 30 and ribs 32 effectively seal off the joint 4 against pressing water, a flow around the hollow profile extrusion 2 being prevented along the bottom face 8 by the swelling strip 30 and along the top face 7 by the ribs 32.

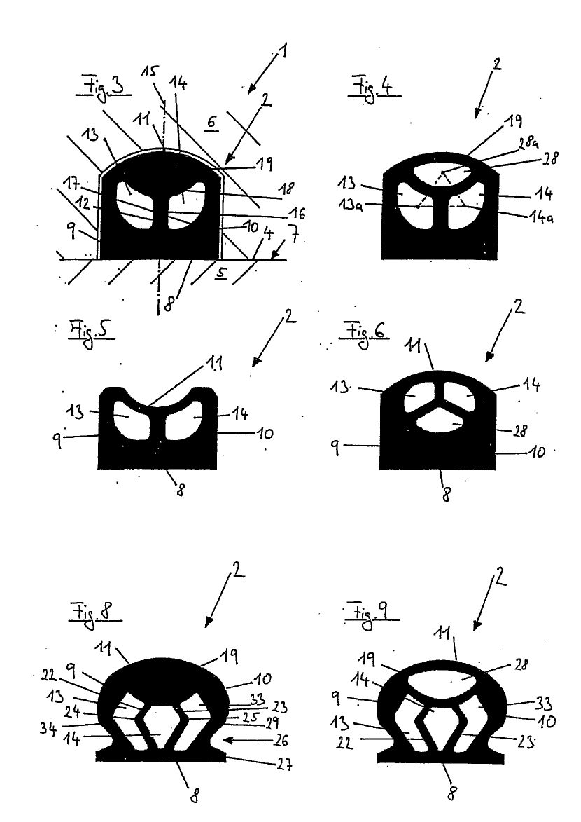

The top wall 11a of the hollow profile extrusion 2 may have a further duct 28 of lenticular cross section (FIG. 4) which ensures a reduction in the necessary deformation force when the injection duct is pressed together with sealing medium. The three-dimensional shape of the hollow profile extrusion 2 according to FIG. 5 has an, in particular, cylindrically channel-shaped top face 11 which ensures an even further reduction in the deformation pressure. In a variant of the hollow profile extrusion according to the invention, as shown in FIG. 6, there is provision for arranging the duct 28 of lenticular cross section on the bottom side and for placing the ducts 13, 14 above this and upside down.

According to a further advantageous embodiment, the hollow profile extrusion 2 has three hollow profile ducts 13, 14, 33 (FIG. 8) which extend in the longitudinal direction and which are separated by supporting walls 22, 23. The cross-sectional shape of the two hollow profile ducts 13, 33 adjacent to the side faces 9, 10 is obtuse-angled, so that they resemble an arrow tip, the latter pointing outward to the respective side face 9, 10. This gives rise to supporting walls 22, 23 which are designed so as to be bent at obtuse angles. This results in predetermined bending points 24, 25 which can be pressed in from above and which point outward, again so as to resemble an arrow tip. Advantageously, the side faces 9, 10 are designed to be rounded in the direction of the bend of the supporting walls 22, 23, so that they, too, can be bent in from above in a similar way to the supporting walls 22, 23. Advantageously, the bending action on the side faces 9, 10 is reinforced by a flute 26 which runs in the longitudinal direction of the hollow profile extrusion 2 on the outside of the side face 9, 10, and which forms a foot 27 on the side face 9, 10 and, consequently, predetermined bending points 29, 34.

Preferably, the predetermined bending points 29, 34 are formed at the same height as the predetermined bending points 24, 25 and are advantageously located in the mid-height region of the hollow profile extrusion 2.

Preferably, as illustrated in FIG. 9, a horizontally lenticular duct 28 is provided above the ducts 13, 14, 33 in a similar way to the hollow profile extrusion 2 according to FIG. 4 and ensures a reduction in the necessary deformation force when the injection duct 3 is pressed together with sealing medium.

Advantageously, the ducts 13, 14, 28, 33 have a fraction of the volume of the hollow profile extrusion 2 of 15-50%, preferably of 20-40%.

The advantageous structural shapes according to FIGS. 3 to 9 may, of course, all be designed with a swelling strip 30 and/or ribs 32.

1. A sealing device (1) for sealing off a joint (4) between a first and second structural body (5, 6), in particular between concrete bodies, comprising an injection duct (3) provided in the region of the joint (4), which is filled or can be filled with a sealing medium in order to seal off the joint (4) and/or voids (4a, 4b) present in the region of the joint (4), the injection duct (3) having arranged in it an extruded spacer body filling the injection duct (3), and the injection duct (3) being formed solely by walls of the structural bodies (5, 6), the extruded spacer body being a hollow profile extrusion (2) which has inside it at least one hollow profile duct preferably continuous in the longitudinal direction, wherein the three-dimensional shape and the material or the internal pressure of the hollow profile extrusion (2) are selected such that the hollow profile extrusion has a three-dimensional shape which withstands the hydrostatic pressure of the wet concrete during the pouring of the second structural body and can be pressed in when sealing medium is pressed into the injection duct (3) and which narrows the cross section and is set back from the walls of the injection duct (3), preferably as far as the joint region.

2. The sealing device as claimed in claim 1, wherein the hollow profile extrusion (2) has inside it at least two hollow profile ducts (13, 14) arranged laterally next to one another and, between the ducts, at least one supporting wall (12) which supports against the wet concrete pressure.

3. The sealing device as claimed in claim 1 wherein the hollow profile extrusion (2) has a planar bottom face (8) seated on a planar concrete surface (7) and two planar side faces (9, 10) running upward at right angles.

4. The sealing device as claimed in claim 1, wherein the hollow profile extrusion (2) has a barrel-vaulted top face (11).

5. The sealing device as claimed in claim 1, wherein inside the hollow profile extrusion (2) are introduced laterally next to one another hollow profile ducts (13, 14) which are separated from one another by a transversely centrally arranged supporting wall (12) oriented vertically and/or parallel to the side faces (9, 10) and which extend preferably continuously in the longitudinal direction.

6. The sealing device as claimed in claim 1, wherein the cross-sectional shape of the ducts (13, 14) is identical.

7. The sealing device as claimed in claim 1, wherein the ducts (13, 14) are arranged symmetrically to a vertical transverse center plane (15) of the hollow profile extrusion (2).

8. The sealing device as claimed in claim 1, wherein the cross-sectional shape of the ducts (13, 14) is approximately triangular and produces a planar supporting wall face (16) which merges into a cylindrical concave duct face (17) located on the bottom-face and side-face side and into a convex duct face (18) in the form of an arc of a cylinder located on the top-face side.

9. The sealing device as claimed in claim 1, wherein the hollow profile extrusion (2) has a top wall (19) of horizontal lenticular cross section.

10. The sealing device as claimed in claim 1, wherein the top wall (19) has a duct (28) of horizontally lenticular cross section, the longitudinal axis (28a) of which forms a triangle with the longitudinal axes (13a, 14a) of the ducts (13, 14).

11. The sealing device as claimed in claim 1, wherein the top face (11) is of channel-shaped, in particular cylindrically channel-shaped design.

12. The sealing device as claimed in claim 1, wherein the duct (28) of lenticular cross section is arranged on the bottom side, and the ducts (13, 14) are formed above it and upside down.

13. The sealing device as claimed in claim 1, wherein the hollow profile extrusion (2) has three hollow profile ducts (13, 14, 33) which are arranged laterally next to one another and extend in the longitudinal direction of the hollow profile extrusion (2) and which are separated by at least two supporting walls (22, 23).

14. The sealing device as claimed in claim 13, wherein the cross-sectional shape of the two ducts (13, 33) adjacent to the side faces (9, 10) is designed at an obtuse angle similarly to an arrow tip, the arrow tip pointing outward to the side faces (9, 10).

15. The sealing device as claimed in claim 14, wherein the supporting walls (22, 23) have predetermined bending points (24, 25).

16. The sealing device as claimed in claim 15, wherein the predetermined bending points (24, 25) are formed on the supporting walls (22, 23) in that the supporting walls (22, 23), starting from their upper end, run first outward and, forming a bending tip, from this inward again to the lower end of the supporting walls.

17. The sealing device as claimed in claim 15 wherein the side faces (9, 10) are designed to be rounded convexly in the direction of the bend of the predetermined bending points (24, 25) of the supporting walls (22, 23).

18. The sealing device as claimed in claim 15, wherein the side faces (9, 10) have predetermined bending points (29, 34) particularly level with the predetermined bending points (24, 25).

19. The sealing device as claimed in claim 1, wherein the predetermined bending points (24, 25, 29, 34) are formed in the mid-height region of the hollow profile extrusion (2).

20. The sealing device as claimed in claim 1, wherein a flute (26) running in the longitudinal direction is formed in that end of the side faces (9, 10) which faces the bottom face (8) and forms a foot (27) in that region of the hollow profile extrusion (2) in which the side faces (9, 10) are contiguous to the bottom face (8).

21. The sealing device as claimed in claim 1, wherein the cavities of the ducts (13, 14, 28, 33) possess a fraction of the volume of the hollow profile extrusion (2) of 15-50%, preferably of 20-40%.

22. The sealing device as claimed in claim 1, wherein, on the bottom face (8) of the hollow profile extrusion (2), a swelling strip (30) in the form of a flat strip is arranged, which consists of material swelling upon the ingress of water.

23. The sealing device as claimed in claim 22, wherein the swelling strip (30) projects with edge webs (31) on both sides of the hollow profile extrusion (2).

24. The sealing device as claimed in claim 22 wherein the swelling strip (30) is produced in one piece with the hollow profile extrusion (2).

25. The sealing device as claimed in wherein, wherein ribs (32) running in the longitudinal direction of the hollow profile extrusion (2) are integrally formed particularly on the side wall faces (9, 10) of the hollow profile extrusion (2).

26. The sealing device as claimed in claim 1, characterized in that the hollow profile extrusion (2) consists of an elastic material.

27. The sealing device as claimed in claim 1, wherein the hollow profile extrusion (2) consists of an elastomeric material.

28. The sealing device as claimed in claim 1, wherein, at least in one of the two structural bodies (5, 6), at least one access, which runs, for example, transversely with respect to the injection duct (3), leads from outside to the injection duct (3) and passes through the structural body, is provided for pressing sealing medium into the injection duct (3).

29. The sealing device as claimed in claim 1, wherein an access hole (21), for example in the form of a bore or of a tube, is introduced from outside as far as the injection duct (3) in one of the two structural bodies (5, 6).

30. A hollow profile extrusion, for a sealing device for sealing off a joint (4) between a first and second structural body (5, 6), in particular between concrete bodies wherein an injections duct (3) provided in the region of the joint (4), which is filled or can be filled with a sealing medium in order to seal off the joint (4) and/or voids (4a, 4b) present in the region of the joint (4), the injection duct (3) having arranged in it an extruded spacer body filling the injection duct (3), and the injection duct (3) being formed solely by walls of the structural bodies (5, 6), the extruded spacer body being a hollow profile extrusion (2) which has inside it at least one hollow profile duct preferably continuous in the longitudinal direction, wherein the three-dimensional shape and the material or the internal pressure of the hollow profile extrusion (2) are selected such that the hollow profile extrusion has a three-dimensional shape which withstands the hydrostatic pressure of the wet concrete during the pouring of the second structural body and can be pressed in when sealing medium is pressed into the injection duct (3) and which narrows the cross section and is set back from the walls of the injection duct (3), preferably as far as the joint region.

31. A method for sealing off a joint (4) between a first and a second structural body (5, 6), in particular between concrete bodies, an injection duct (3) capable of being filled with a sealing medium being introduced in the region of the joint (4), in that, before the concreting of the second structural body (6), an extruded spacer body keeping the injection duct (3) free during concreting and displaceable by injection medium is laid in place, so that the injection duct (3) is formed solely by walls of the structural bodies (5, 6), wherein the extruded spacer body used is a hollow profile extrusion (2) which has inside it at least one hollow profile duct preferably continuous in the longitudinal direction, wherein the three-dimensional shape and the material or the internal pressure of the hollow profile extrusion (2) are selected such that the hollow profile extrusion has a three-dimensional shape which withstands the hydrostatic pressure of the wet concrete during the pouring of the second structural body and can be pressed in when sealing medium is pressed into the injection duct (3) and which narrows the cross section and is set back from the walls of the injection duct (3), preferably as far as the joint region.

32. The method as claimed in claim 31, wherein, before or during concreting or after the solidification or setting of the second structural body (6), at least one hollow profile duct (13, 14, 28, 33) in the hollow profile extrusion (2) is subjected to a pressure medium.

33. The method as claimed in claim 31, wherein the pressure of the pressure medium is broken down after the stiffening and/or setting of the concrete.

34. The method as claimed in claim 31, wherein the hollow profile extrusion (2) remains subjected to a pressure after the setting of the concrete of the second structural body (6).

35. The method as claimed in claim 31, wherein, to seal off the joint (4) and/or voids (4a, 4b) in the joint region, sealing medium is injected into the injection duct (3) with a pressure which dents and/or collapses the hollow profile extrusion (2).

36. The method as claimed in claim 31, wherein the sealing medium used is a curing liquid plastic, in particular polyurethane.

37. The method as claimed in claim 31, wherein the sealing medium is injected from one end face of the injection duct (3), in particular by means of a valve device.

38. The method as claimed in claim 31, wherein, before and/or during the injection of the sealing medium, at least one hollow profile duct (13, 14, 28, 33) in the hollow profile extrusion (2) is subjected to a vacuum.

39. The method as claimed in claim 31, wherein, the hollow profile extrusion (2) is dented or collapsed by means of a vacuum.

40. The method as claimed in claim 31, wherein a hollow profile duct (13, 14, 28, 33) and another hollow profile duct (13, 14, 28, 33) are simultaneously subjected the former to a vacuum and the latter to excess pressure.

41. The method as claimed in claim 31, wherein, for the directed injection of sealing medium into a joint region, at least one access hole (21) is drilled so as to lead from an outside of the second structural body (6) as far as the injection duct (3).

42. The method as claimed in claim 31, wherein, during the concreting of the second structural body (6), at least one access (21) is generated at a predetermined point, for example in that at least one spacer and/or one tubular bar is laid so as to lead from the injection duct (3) to an outside of the second structural body (6).

43. The method as claimed in claim 31, wherein sealing medium is injected into the joint region and/or voids (4a, 4b) via the access (21).
